(19) United States
(12) Patent Application Publication
(10) Pub. No.: US 2023/0034744 A1
(43) Pub. Date: Feb. 2, 2023

(54) METHOD FOR FABRICATING MULTILAYER CERAMIC STRUCTURES BY THERMAL SPRAYING

(71) Applicant: ASELSAN ELEKTRONIK SANAYI VE TICARET ANONIM SIRKETI, Ankara (TR)

(72) Inventors: Hansu BIROL, Ankara (TR); Ozgur BIRER, Ankara (TR); Akin DALKILIC, Ankara (TR); Mehmet Erim INAL, Ankara (TR); Sebnem SAYGINER, Ankara (TR)

(73) Assignee: ASELSAN ELEKTRONIK SANAYI VE TICARET ANONIM SIRKETI, Ankara (TR)

(21) Appl. No.: 17/786,583

(22) PCT Filed: Sep. 9, 2020
(86) PCT No.: PCT/TR2020/050819

§ 371 Date: Jun. 17, 2022

(30) Foreign Application Priority Data
Dec. 26, 2019 (TR) 2019/21786

(51) Int. Cl. C23C 4/11; H01Q 1/42; C23C 4/01; C23C 4/02

(52) U.S. Cl. CPC C23C 4/11; H01Q 1/422; C23C 4/01; C23C 4/02

(57) ABSTRACT

A method for fabricating multi-layer ceramic broadband radome includes thermal-spraying layers of coating materials on the radome. The assembled structure exhibits tuned RF transparency response depending on the thickness and the dielectric constant of the deposited layers. Sub-micron thick ceramic layers, which are essential for broadband performance and hard to produce due to their fragile nature, can be deposited on big and complex objects by a fast and automated process.

### CROSS REFERENCE TO THE RELATED APPLICATIONS

This application is the national phase entry of International Application No. PCT/TR2020/050819, filed on Sep. 9, 2020, which is based upon and claims priority to Turkish Patent Application No. 2019/21786, filed on Dec. 26, 2019, the entire contents of which are incorporated herein by reference.

### TECHNICAL FIELD

The present invention is a method for fabricating multi-layer ceramic broadband radome by thermal-spraying ceramic coating materials on the radome.

### BACKGROUND

Missile radomes operating at higher Mach numbers encounter extreme conditions such as elevated temperatures, thermal and mechanical loads and environmental constraints (rain/dust/sand fields, humidity, etc.). As a consequence of these challenges, the radome material is usually selected from ceramics to fulfill the requirements at super/hypersonic speeds for extended flight times. There is very few information on as such radomes and much less for those protecting seekers operating in broadband.

Broadband radio frequency (RF) capability is facilitated by a monolithic structure that is composed of multiple layers. Each layer has a specific thickness and dielectric constant contributing to the overall RF response in the desired frequency range.

Broadband missile radomes developed by joining low and high dielectric layers are cited in open literature, particularly for organic-based materials. Low dielectric layers are mostly foams, honeycombs, low density engineering plastics of organic nature (PTFE, Duroid, PVC diisocyanate, polyesterimide, polymethaacrylimide and the like). Some of these materials can also be mixed with silicon, inorganic fillers, and glass fibers to increase the mechanical and thermal resistance of the layer. High dielectric layers are quartz fibers, E or S2 glass fibers and fabrics, which are alternatively mixed in a resin. Both of these layers are prepared separately and joined together by using traditional composite manufacturing techniques.

There are several drawbacks of radomes manufactured by these techniques:
These radomes are not hermetic, and they absorb humidity over time, which alter the dielectric properties (aging).
The processes entail several consecutive steps such as cutting, laying, dispersing, infiltrating, pressing/shaping, curing. Most of these processes are semi-automated.
Termination state of most of these processes such as infiltration, pressure, curing are incomplete.
Degradation of these radomes is accelerated at elevated temperatures and during prolonged flight times.

Multi-layered broadband missile radome topic is much less cited for monolithic ceramic materials. This can be ascribed to several factors:
Fragility of ceramic at fine thicknesses (0.3-0.6 mm), which is typical value for high dielectric constant layers of sandwich structures.
Complicated integration of such thin layers to the core layers by using conventional techniques.
Unmatched CTE (Coefficient of Thermal Expansion) between the high and low dielectric constant layers.

In this domain, U.S. Pat. No. 4,358,772 presents slip cast fused silica radome with Si₃N₄ skin layers, which are deposited by CVD (Chemical Vapour Deposition). However, it is not very clear how a big and porous silica radome is chemical vapour deposited in a typically small CVD chamber.

Most of the previous work on broadband radomes is devoted on sandwich structures. The layers in these radomes are composed of high and low dielectric layers, the former being much thinner than the latter, in the vicinity of 0.3-0.6 mm. The specific broadband designs are named as A, B, C, D sandwich depending on the order of the layers.

In U.S. Pat. No. 5,408,244, a D-sandwich design suitable for DC to 100 GHz range is presented. The structure is built up of high and low dielectric layers, which are glass fibers in resin matrix and RT/Duroid, respectively. U.S. Pat. No. 5,738,750 demonstrates an A-type sandwich where a low dielectric honeycomb filled with fused woven fibers are neighbored with quartz clothes. Similar to these patents, U.S. Pat. Nos. 6,028,565, 6,109,976, 10,321,236, and EP No. 2,747,202 demonstrate different sandwich structures with high dielectric layers by using quartz fibers, E or S2 glass fibers and low dielectric layers by using silicon-based foams, polyimide foams and fabrics.

All of these studies rely on different Polymer Matrix Composite (PMC) manufacturing techniques, which entail infiltrating, press-shaping, curing layers. Moreover, it is not very clear how the radome is shaped and post processed to fulfill the geometrical tolerances.

In U.S. Pat. No. 8,765,230, Thermal Barrier Coating (TBC) materials are presented in conjunction with radomes, which are claimed to reduce excessive temperatures effectively. However, the patent has no insight to broadband characteristics of the radome.

### SUMMARY

Thermal spraying of sub-mm-thick ceramic layers on big and complex ceramic objects is the focus of the invention. The assembled structure exhibits tuned RF transparency response depending on the thickness and the dielectric constant of the deposited layers. Application is straight forward as it entails discrete thermal spraying sessions during short periods of time. This is a significant improvement compared to conventional multi-layering techniques since a broad range of material options can be coated without the use of additional processes. The technique is an alternative to develop broadband ceramic radomes with higher productivity.

Compared to other multi-layer ceramic, PMC, CMC radome production techniques, the method disclosed in this patent entails the following unique features:
Sub-micron thick ceramic layers, which are essential for broadband performance and hard to produce due to their fragile nature, can be deposited on big and complex objects by a fast and automated process.
Technically, all materials can be deposited or sprayed to form a sub-mm layer as long as they do not decompose up on melting. This facilitates the application of a wide range of materials to pick from for the desired performance.
Deposited layer thickness is homogenous and adjustable. This offers extra freedom in RF design capability.
Thermal spraying process is direct and automated; there are no layer preparation and joining steps such as cutting, infiltration, lamination, shaping and curing.
Thermal spraying process for a specific substrate-coating material combination can be customized and optimized. CWS (Combustion Wire Spray), CPS (Combustion Powder Spray), Electric Arc Wire Spray, APS (Atmospheric Plasma Spray, HVOF (High Velocity Oxy-Fuel Spray) are different thermal spraying techniques with varying kinetic and thermal energy capacity. This facilitates the use of the correct deposition materials adequately for specific surface and applications.
Coating can be partially-applied on the object by using screens or filters depending on the position of the RF seekers and other electronic components in the radome. By doing so, the radome can be segmented in specific locations for tailored performance of specific RF components. This approach further limits the coating material quantity and the possible CTE mismatch in critical parts of the radome.

### BRIEF DESCRIPTION OF THE DRAWINGS

FIG. 1 shows thermal spraying of big and complex ceramic objects such as radome.

FIG. 2A shows the RF transmission behavior of the virgin or single layer/single material sample.

FIG. 2B shows the RF transmission behavior of the A-sandwich composed of high and low dielectric constant materials.

FIG. 3 shows outer and inner coating of radome surfaces.

FIG. 4 shows A-sandwich, B-sandwich, C-sandwich, and D-sandwich respectively, where the grey layers indicate the low dielectric layers.

FIG. 5 shows multi-layers with different materials and segmented coating adopted for seeker's directionality range (example for an A-sandwich) respectively.

### DETAILED DESCRIPTION OF THE EMBODIMENTS

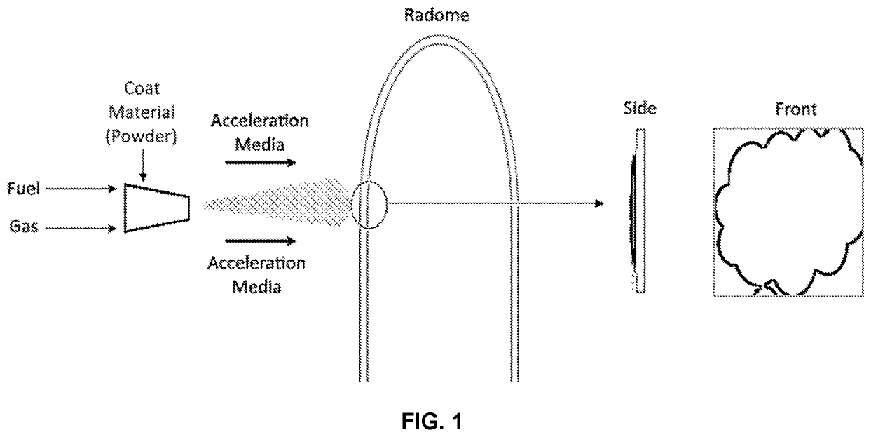

Thermal spraying is a coating process, where the melted coating material, is directed on to the substrate material at elevated speeds (FIG. 1). The binding between the coat and the substrate is predominantly mechanical due to the sudden solidification of the melt on the cold substrate surface [1]. The process is standardized and effectively used in numerous industry sectors, where extreme thermal and mechanical conditions alter the surface quality of the materials in operation constantly [1-4].

There are several processing parameters to consider in thermal spraying. Size, shape, reactivity, morphology, and surface properties of the coating powders significantly influence the productivity. Moreover, different processes are employed under the general title of thermal spraying context depending on the atmosphere, heat source, gases and velocities used to generate extreme heat and to accelerate the coat particles. This is one of the reasons why the materials selection range and the achievable thickness are very broad compared to other coating techniques.

In conventional flame spraying, the feed material, which is coated on the substrate, can be in wire or powder form and hence, the technique is named as CSW (Combustion Wire Spray) or CPS (Combustion Powder Spray). Typical coating thickness is around 0.04-2.50 mm and a maximum of 3,000° C. is reached in this technique [1, 4]. Electric Arc Spray is another option where the applied voltage forms an arc that melts the material around 4,000° C. and blows it on to the surface at a speed around 0.5 Mach [1]. APS (Atmospheric Plasma Spray) melts the powder (ceramic/polymer/metal) in plasma arc up to 16,000° C. and the particles move towards the target at supersonic velocity (˜1.5 Mach) [1, 3]. Technically, any material can be melted and coated by APS unless the material decomposes. HVOF (High Velocity Oxy-Fuel) is another thermal spraying technique that melts the materials at 3,000° C. and accelerates them to the target at a speed of 1.5-3 Mach [1]. Each of these techniques is optimized for specific materials and applications and they vary based on their thermal and kinetic capabilities [2, 4]. Among all, HVOF is the most suitable technique, which melts the materials up to a sufficiently high temperature without passing the heat to the substrate. Adhesion of the coating material is mostly achieved by the supersonic flight in this case [1, 4].

Multi-layer broadband ceramic radome fabrication is achieved by thermal spraying process. The substrate to be coated is a monolithic ceramic radome, which is manufactured by conventional manufacturing techniques such as slip casting, hot casting, spin casting, additive manufacturing (by treating binders and powders by SLS—Selective Laser Sintering, SLM—Selective Laser Melting, SPS—Spark Plasma Sintering, LOM—Laminated Object Manufacturing, FDM—Fused Deposition Modeling, DLP—Digital Light Processing and Lithography such as STLA—Stereo Lithography), composite manufacturing by using polymer/ceramic filled prepregs, fiber winding and impregnation/infiltration. The radome material can be selected from a series of well-known ceramics such as fused SiO₂, Al₂O₃, Si₃N₄, LAS (Lithium Aluminum Silicate), MAS (Magnesium Aluminum Silicate). These materials exhibit specific thermal, mechanical and electrical properties, which play a major role in selection of the thermal spraying technique. Except for fused SiO₂, all of the aforementioned materials have limited thermal shock and thermo-stability resistances. Moreover, their properties are altered significantly when the thermal energy of the molten particles are impinged on them with high kinetic energy.

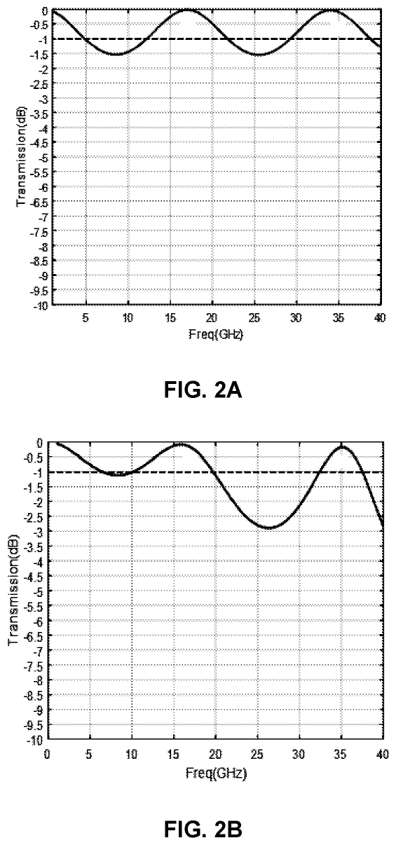

Thermal spraying process is effective in building sub-mm-thick layers on the desired substrate. Fabrication and integration of such thin ceramic layers is an essential and complicated step for preparation of multi-layer structures, particularly the sandwich structures (A, B, C, D) exhibiting broadband RF performance. The RF transparency of 2 designs using the same material are compared and presented in FIG. 2A and FIG. 2B. The samples are:
virgin or single layer/single material sample (FIG. 2A),
A-sandwich composed of high and low dielectric constant materials (FIG. 2B),

The RF transparency is measured in the 0-40 GHz range for all samples. As it is shown in FIGS. 2A and 2B, the RF response of the virgin sample is improved by sandwich design at lower frequency.

There are several coating materials with specific features to protect the substrate surfaces. ZrO₂, YSZ (Y: 3-18%), Mg-stabilized YSZ, mullite, Al₂O₃, Al₂O₃+TiO₂, CeO₂, La₂Zr₂O₇, BaZrO₃, TiO₂, garnet, lanthanum aluminate, LaPO₄, NiCoCrAlY, YAlO₃ are some of the ceramic-based coat materials, which are frequently used in thermal spraying [3]. For these materials to be deposited on ceramic radome, several criterias must be checked and fulfilled. The substrate must withstand thermal-shocks due to the confrontation of hot particles with cold surface. This requires an optimal combination of thermal conductivity with stable thermal expansion behavior of the substrate over a wide temperature range. The surface properties of the substrate are another critical factor impacting the adhesion. For improved adhesion quality, the substrate might need extra processes such as sand blasting, chemical etching, pulsed laser ablation techniques which increase the surface area to increase the adhesion strength. The spraying technique also plays an important role in the coating process. Very high thermal energies necessary to melt ceramic particles can be fast-cooled during flight by higher velocity streams (kinetic energy), which prevents the substrate to receive extra heat. Most of all, the coated layers should not deteriorate the RF performance of the radome.

The starting point for multi-layer ceramic radome fabrication is the substrate, which is the ceramic radome. Traditional radome materials can be picked from monolithic ceramics such as fused SiO₂, Al₂O₃, Si₃N₄, LAS (Lithium Aluminum Silicate), MAS (Magnesium Aluminum Silicate) as well as PMC and CMC's. Monolithic radomes can be manufactured by casting, melt pouring, traditional polymer or ceramic composite processes. In casting, the ceramic powder is mixed and milled with a suitable vehicle for size reduction and homogenization. The so called slip with adequate colloidal stability is achieved through additives (acid based or organic polymers), which is then poured into a mold for shaping. The radome is removed from the mold after gaining a desired thickness, dried in air for extended periods and sintered. In melt pouring route, molten glass at specific composition, temperature and viscosity is poured on a male mold, which is spinned around its central axis and then covered with a female mold. Both methods follow post processes such as grinding and polishing to attain tight thickness and planarity tolerances. Depending on the ceramic material, the surface can also be impermeabilized by use of a high temperature wax or resin. Composites are formed either by winding single filaments over mandrels and filling them by resins/suspensions or by joining polymer resin impregnated or ceramic suspension infiltrated fabrics. Following shaping and sintering, the radome material is machined to exhibit the tight thickness and planarity tolerances critical for the RF performance.

Once the radome is available, its polished surface needs to be prepared properly to accommodate the thermally sprayed particles. Mechanical locking or hooking of the molten material can be improved by increasing the surface area of the substrate. Different chemical, mechanical or thermal processes can be employed with this purpose. Acid etching is a chemical process to increase the surface roughness, which has to be conducted carefully not to over-alter the surface chemistry of the substrate. Mechanical methods such as grinding and sand-blasting can also be used to increase the roughness unless the surface properties and/or dimensional tolerances are significantly changed. Pulsed laser ablation is effective in introducing fine-defined surface roughness through thermal energy. It is found imperative to increase the ceramic surface roughness for improved adhesion of molten materials.

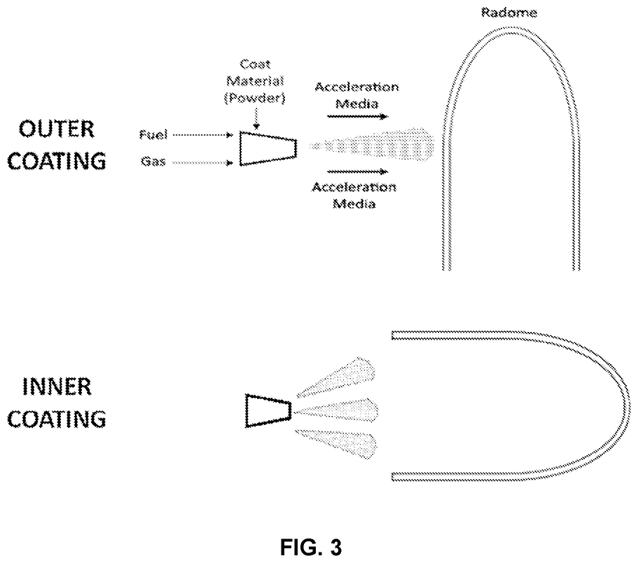

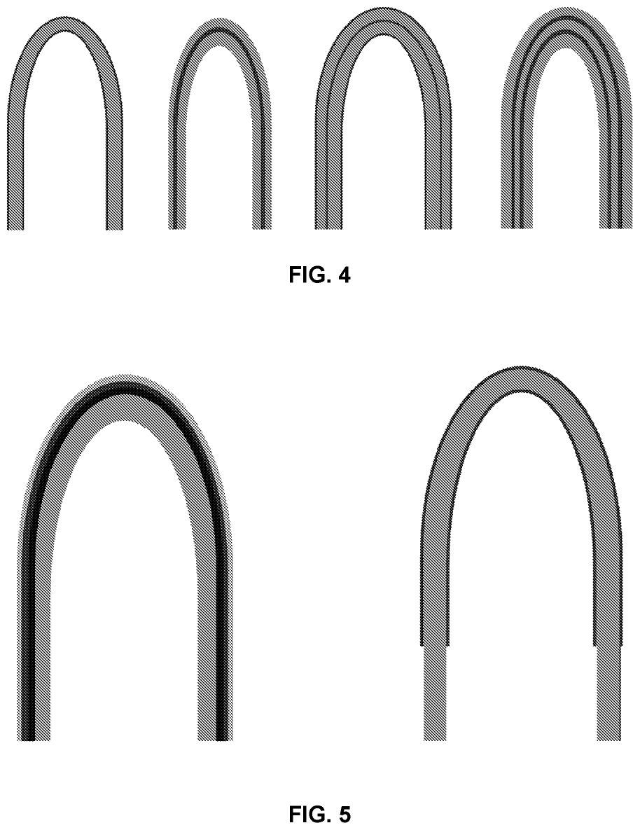

Following surface modification of the ceramic radome, the coat material is thermally sprayed. Smaller thermal spray systems can be integrated with robot arms to coat “hard to reach” points in closed sections such as the radome interior. Depending on the material and the thickness range preferred, the appropriate technique can be employed. HVOF is capable of melting most of the aforementioned coat materials whilst passing the minimum amount of thermal energy to the substrate compared to other thermal spraying techniques. The multiple layers can be deposited on outer and inner surfaces of the radome (FIG. 3), which result in designs exhibiting the broadband RF behavior:
A-sandwich: Thick (few mm) and low dielectric constant radome is coated with thin (sub-mm), high dielectric constant material on outer and inner surfaces (FIG. 4).
B-sandwich: A thin (sub-mm) and high dielectric constant radome is coated with thick (few mm), low dielectric constant material on outer and inner surfaces (FIG. 4). CSW and CPS techniques can coat materials up to 2.50 mm thickness, which can be used successfully for thick layers.
C-sandwich: It is an extension of A-sandwich. The additional layers on and in the A-sandwich are formed by thermal spraying of thick and low dielectric constant material (FIG. 4).
D-sandwich: It is an extension of B-sandwich. However, the additional layers on and in the B-sandwich are formed by thermal spraying of thin and high dielectric constant material (FIG. 4).
Segmented radome structures: Coating pre-defined locations of the radome by screening the jetted coat materials on to the surface. This approach can be applied for all of the aforementioned sandwich options. FIG. 5 shows the segmented structure prepared for A-sandwich.

The character of the thermally sprayed surface is usually porous and deformed with cracks. Over multiple layers in thickness direction, a more uniform cross section is formed. The final process of thermal spraying is surface polishing, which is executed in multiple steps to reduce the surface roughness. This brings thickness and planarity values to the tight tolerances required for the optimized RF specs.

### REFERENCES

1 Oerlikon Metco, An Introduction to Thermal Spraying, Company white paper, 2016, 1-24.
2 X. Q. Cao, R. Vassenb and D. Stoeverb, Ceramic Materials for Thermal Barrier Coatings, Journal of the European Ceramic Society, 24, 2004, 1-10.
3 E. Bakan and R. Vassen, Ceramic Top Coats of Plasma-Sprayed Thermal Barrier Coatings: Materials, Processes, and Properties, Journal of Thermal Spray Technology, 26, 2017, 992-1010.

What is claimed is:

1. A method for fabricating multi-layer ceramic broadband radome, comprising thermal-spraying layers of ceramic coating materials on a radome.

2. The method according to claim 1, wherein an exterior and an interior of the radome is coated by sub-mm thick layers of the ceramic coating materials.

3. The method according to claim 1, comprising partially coating the radome by using screens or filters depending on a position of electronic components in the radome.

4. The method according to claim 1, wherein the thermal-spraying step is performed by using a thermal spraying technique selected from the group consisting of combustion wire spray, combustion powder spray, electric arc wire spray, atmospheric plasma spray, and high velocity oxy-fuel spray.

5. The method according to claim 1, wherein before the thermal-spraying step, a surface of the radome is processed by grinding, sand blasting, chemical etching, or pulsed laser ablation techniques to increase a surface area and an adhesion strength of the randome.

6. The method according to claim 1, further comprising machining a surface of the randome coated with the ceramic coating materials to fulfill a desired thickness tolerances for an optimized radio frequency (RF) response.
